(19) United States
(12) Patent Application Publication
(10) Pub. No.: US 2026/0022013 A1
(43) Pub. Date: Jan. 22, 2026

(54) INTEGRATED PROCESS FOR REDUCING CO2 EMISSIONS FROM TRANSPORT AND POWER GENERATION

(71) Applicant: SAUDI ARABIAN OIL COMPANY, Dhahran (SA)

(72) Inventors: Alexander Voice, Novi, MI (US); Tianyu Gao, Beaverton, OR (US); Chanel Sitto, Novi, MI (US); Esam Hamad, Novi, MI (US); Dave J. Edlund, Bend, OR (US)

(73) Assignee: ARAMCO SERVICES COMPANY, Houston, TX (US)

(21) Appl. No.: 18/777,878

(22) Filed: Jul. 19, 2024

(51) Int. Cl. C01B 3/34; B01D 53/14; B01D 53/22; B01D 53/62; B01D 53/78; B01D 53/96; C01B 3/50

(52) U.S. Cl. CPC C01B 3/34; B01D 53/1425; B01D 53/1475; B01D 53/229; B01D 53/62; B01D 53/78; B01D 53/96; C01B 3/501; B01D 2252/2026; B01D 2256/20; B01D 2257/504; C01B 2203/0216; C01B 2203/0405; C01B 2203/047; C01B 2203/0475; C01B 2203/0495; C01B 2203/066; C01B 2203/0827; C01B 2203/0833; C01B 2203/1223

(57) ABSTRACT

A hydrogen generation and carbon capture system includes a fuel reformer, hydrogen purifier, fuel cell, three heat exchangers, two knockout drums, absorber, burner feed pressure regulator, burner, flash tank, solvent trim cooler, and condenser. A process for hydrogen generation and carbon capture includes pumping, heating, and reforming a fuel and water feed. The process includes extracting hydrogen from a raw syngas, directing hydrogen to a fuel cell, separating liquid from a cooled carbon monoxide and carbon dioxide rich syngas mixture and feeding this stream to an absorber. The process includes reducing pressure and burning the syngas mixture, heating the carbon dioxide rich solvent stream, and cooling the cooled regenerated solvent. The process includes heating the heated carbon dioxide rich solvent stream, separating carbon dioxide from the stream, condensing the carbon dioxide stream, and separating liquid from the gas/liquid mixture.

### BACKGROUND

The marine shipping industry is under pressure to decarbonize its operations to address the impact the industry has on climate change. Specifically, the International Maritime Organization shared their IMO GHG (greenhouse gas) Strategy, including a goal to reach net-zero greenhouse gas emissions from international shipping by, or close to, 2050.

Conventionally, fuel saving measures including engine and vessel efficiency improvements have been targeted in these efforts. This may assist in reducing the greenhouse gas emissions per vessel. However, with an increasing need for international shipping, this may not be sufficient to address the overall impact of the marine shipping industry. Carbon capture is a strategy of greenhouse gas emissions reduction widely studied in industrial applications on land. Accordingly, there exists a need for a system and process for reducing greenhouse gas emissions using carbon capture, storage, and transportation on a marine vessel.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a hydrogen generation and carbon capture system for marine applications including a fuel reformer for reacting a fuel and water feed from a marine vessel to produce a raw syngas mixture containing hydrogen, carbon monoxide, carbon dioxide, water and a residual amount of fuel. A hydrogen purifier extracts a hydrogen stream from the raw syngas mixture, producing a carbon monoxide and carbon dioxide rich syngas mixture. A fuel cell produces electricity from the hydrogen stream as a power source. A first heat exchanger transfers heat from the carbon monoxide and carbon dioxide rich syngas mixture to the fuel and water feed to produce a cooled carbon monoxide and carbon dioxide rich syngas mixture. A first knockout drum removes an amount of liquid from the carbon monoxide and carbon dioxide rich syngas mixture, producing a dried cooled carbon monoxide and carbon dioxide rich syngas mixture. An absorber transfers an amount of carbon dioxide from the dried cooled carbon monoxide and carbon dioxide rich syngas mixture to a further cooled regenerated solvent stream to produce a carbon dioxide rich solvent stream and a carbon monoxide rich syngas mixture. A burner feed pressure regulator reduces the pressure of the carbon monoxide rich syngas mixture to produce a low pressure carbon monoxide rich syngas mixture. A burner is coupled to the fuel reformer to provide heat to the fuel reformer by combusting the low pressure carbon monoxide rich syngas mixture to produce an exhaust gas. A second heat exchanger transfers heat from a regenerated solvent stream to the carbon dioxide rich solvent stream to produce a cooled regenerated solvent stream and a heated carbon dioxide rich solvent stream. A third heat exchanger provides additional heat to the heated carbon dioxide rich solvent stream using heat from the exhaust gas to regenerate the heated carbon dioxide rich solvent stream. A flash tank further separates the heated carbon dioxide rich solvent stream to produce the regenerated solvent stream and a carbon dioxide stream. A solvent trim cooler further reduces a temperature of the cooled regenerated solvent stream into the absorber producing the further cooled regenerated solvent stream. A condenser produces a gas/liquid mixture containing gascous carbon dioxide and liquid components. A second knockout drum removes the liquid components from the gas/liquid mixture to produce a vapor carbon dioxide stream for temporary storage on a marine vessel before unloading on land.

In another aspect, embodiments disclosed herein relate to a process for hydrogen generation and carbon capture for marine applications. A fuel and water feed is pumped from a marine vessel producing a pressurized fuel and water feed. The pressurized fuel and water feed is heated via a first heat exchanger using a carbon monoxide and carbon dioxide rich syngas mixture to produce a heated pressurized fuel and water feed and a cooled carbon monoxide and carbon dioxide rich syngas mixture. The heated pressurized fuel and water feed is reformed using a fuel reformer, producing a raw syngas mixture containing hydrogen, carbon monoxide, carbon dioxide, water, and a residual amount of fuel. The hydrogen from the raw syngas mixture is extracted using a hydrogen purifier, producing a hydrogen stream and the carbon monoxide and carbon dioxide rich syngas mixture. The hydrogen stream is directed to a fuel cell for producing electricity. An amount of liquid from the cooled carbon monoxide and carbon dioxide rich syngas mixture is separated using a first knockout drum, producing a dried cooled carbon monoxide and carbon dioxide rich syngas mixture and a liquid waste stream. The dried cooled carbon monoxide and carbon dioxide rich syngas mixture is fed along with a further cooled regenerated solvent stream to an absorber to selectively transfer the carbon dioxide from the dried cooled carbon monoxide and carbon dioxide rich syngas mixture to the further cooled regenerated solvent stream, producing a carbon dioxide rich solvent stream and a carbon monoxide rich syngas mixture. The pressure of the carbon monoxide rich syngas mixture is reduced using a burner feed pressure regulator, producing a low pressure carbon monoxide rich syngas mixture. The low pressure carbon monoxide rich syngas mixture is burned in a burner coupled to the fuel reformer to provide heat to the fuel reformer and produce an exhaust gas stream. The carbon dioxide rich solvent stream is heated via a second heat exchanger using a regenerated solvent stream to produce a cooled regenerated solvent stream and a heated carbon dioxide rich solvent stream. The cooled regenerated solvent stream is further cooled using a solvent trim cooler, producing the further cooled regenerated solvent stream. The heated carbon dioxide rich solvent stream is further heated via a third heat exchanger using the exhaust gas to heat the heated carbon dioxide rich solvent stream, producing a further heated carbon dioxide rich solvent stream and a cooled exhaust gas stream. A portion of carbon dioxide from the further heated carbon dioxide rich solvent stream is separated using a flash tank to produce the regenerated solvent stream and a carbon dioxide stream. The carbon dioxide stream is condensed to produce a gas/liquid mixture containing gaseous carbon dioxide and liquid components. The liquid components are separated from the gas/liquid mixture using a second knockout drum, producing a vapor carbon dioxide stream for temporary storage on a marine vessel before unloading on land.

Other aspects and advantages of the claimed subject matter will be apparent from the following description and the appended claims.

### BRIEF DESCRIPTION OF DRAWINGS

FIG. 1 is an overall process flow diagram of a carbon capture system in accordance with one or more embodiments.

FIG. 2 is an alternative embodiment of an overall process flow diagram of a carbon capture system in accordance with one or more embodiments.

FIG. 3A is a graph of absorber diameter versus liquid flow rate in accordance with one or more embodiments.

FIG. 3B is a graph of capture rate versus liquid flow rate in accordance with one or more embodiments.

FIG. 4 is a graph of lean loading and capture rate versus liquid flow rate in accordance with one or more embodiments.

FIG. 5 is a graph of flash pressure versus flash temperature in accordance with one or more embodiments.

FIG. 6A is a graph of capture rate versus liquid flow rate in accordance with one or more embodiments.

FIG. 6B is a graph of specific heat versus liquid flow rate in accordance with one or more embodiments.

FIG. 6C is a graph of total work versus liquid flow rate in accordance with one or more embodiments.

FIG. 7 is a graph of carbon intensity versus capture rate in accordance with one or more embodiments.

FIGS. 8A-8D illustrate lean loading against flow rate in accordance with one or more embodiments.

### DETAILED DESCRIPTION

In one aspect, embodiments disclosed herein relate to a steam reforming system for hydrogen production and carbon capture for marine applications. In another aspect, embodiments disclosed herein relate to a process for hydrogen production and carbon capture using steam reforming for marine applications. Embodiments disclosed herein relate to steam reforming of various fuels including methanol, diesel, other liquid fuels, and natural gas. Other liquid fuels may include, but are not limited to, ethanol, kerosene, aviation fuels, synthetic aviation fuels, biodiesel, gasoline, and dimethyl ether (DME).

Embodiments disclosed herein relate to reforming fuel in a fuel reformer, feeding a resulting syngas mixture from the reformer to an absorber, using a product of the absorber to drive heat to the reformer, and using the other absorption product to capture carbon dioxide and regenerate a solvent to continually process fuel through the system.

Embodiments disclosed herein relate to capturing carbon dioxide, accumulating the carbon dioxide, and storing it on a marine vessel for transportation. The carbon dioxide is unloaded onto land at ports to be distributed and transported to storage locations for geological sequestration, onward transportation, immediate utilization, or other purposes. Embodiments disclosed herein also relate to generating power through the steam reforming process to provide motive power to a marine vessel.

To capture the carbon dioxide, a fuel and water feed is pumped through a first heat exchanger before being fed to a fuel reformer to react the fuel and water. Both the fuel and the water are stored on the marine vessel for this use. The fuel reformer produces a syngas mixture containing hydrogen, carbon monoxide, carbon dioxide, water, and a residual amount of fuel. The fuel reformer is heated by a burner coupled to the fuel reformer. The burner contains a blower. The produced syngas mixture exiting the fuel reformer is separated in a hydrogen purifier. The purifier may contain a hydrogen-selective membrane, which separates the hydrogen from the remainder of the syngas mixture. The separated hydrogen is provided to a fuel cell for producing electricity from the hydrogen stream, which can in turn be used for propulsion, for example, by spinning an electric motor that spins a propeller on the marine vessel. The power source may also provide power to pumps and the compressor in the system, and other auxiliary power systems onboard the vessel. The remainder of the syngas mixture is cooled in the first heat exchanger, as the heat transfers to the fuel and water feed, as described above.

The cooled carbon monoxide and carbon dioxide rich syngas mixture flows through a first liquid knockout drum to remove liquid and produce a dried cooled carbon monoxide and carbon dioxide rich syngas mixture that is fed to the absorber. The first liquid knockout drum removes excess liquid primarily, and the dried cooled carbon monoxide and carbon dioxide rich syngas mixture may still be saturated, or contain some, water. A liquid knockout drum is a separation unit that separates a liquid from a mixture. The absorber removes the carbon dioxide from the syngas mixture and transfers it to the solvent entering into the absorber. In some embodiments, the absorber may be in a cross-flow arrangement, arranged as a rotating packed bed, or may be a hollow fiber membrane contactor absorber. The solvent fed to the absorber is adjusted to a specific temperature prior to feeding to the absorber using a solvent trim cooler. The solvent trim cooler cools the cooled regenerated solvent stream to a temperature in a range of 10 to 80° C. There may be a backpressure valve at an outlet from the absorber to monitor and/or maintain a system pressure at a range of at least 5 atm. Higher pressure in the absorber is advantageous for providing a driving force for carbon dioxide capture; however, it may impact the cost and performance of the fuel reformer, as well as other components in the system upstream of the absorber.

The absorber uses the high pressures generated by the fuel reformer to drive the carbon dioxide separation. Using temperature and pressure swing absorption achieves heat rates of approximately 0.6 to 0.9 kJ/gCO₂, compared to approximately 1.9 to 2.3 kJ/gCO₂ of available heat in the exhaust gas exiting the fuel reformer due to the temperature of the exhaust gas being approximately 195 to 265° C.

The remaining carbon monoxide rich syngas mixture is fed, at a lower pressure than it exits the absorber, to the burner coupled to the fuel reformer. The burner combusts the carbon monoxide rich syngas mixture in the presence of air from the blower. The exhaust gas resulting from this combustion is then used to provide heat to the absorber.

Effective solvents for use in the absorber may include a high-capacity chemical solvent such as methyl-diethanolamine, diethanolamine, piperazine, and diglycolamine. In one or more embodiments, the regenerated solvent stream contains 30 to 80 wt % amine in water. Physical solvents may be suitable, including mixtures of dimethyl ethers of polyethylene glycol (Selexol™), methanol, sulfolane, pyrrolidones, imidazoles, organic carbonates, poly-ethers, other suitable polyols, or any other organic substance which can absorb carbon dioxide without a chemical reaction taking place. In some embodiments, both a high-capacity chemical solvent and a physical solvent may be included in the regenerated solvent stream. Aqueous methanol may be particularly advantageous compared to pure methanol due to low cost and additional hydrogen production potential from the water present in it. As the effluent of the carbon dioxide capture plant is combusted in the burner, higher volatility solvents may be useful in the absorber that would normally produce unacceptable high emissions in conventional systems. The carbon dioxide rich solvent stream enters a carbon dioxide treatment portion of the system for release of the carbon dioxide from the solution and regeneration of the solvent for continuous operation. The carbon dioxide treatment portion of the system includes a second heat exchanger, a third heat exchanger, a flash tank, a second knockout drum, and a compressor. The second heat exchanger heats the carbon dioxide rich solvent stream using the hot, carbon dioxide lean regenerated solvent stream to provide heat. The heated carbon dioxide rich solvent stream is further heated in a third heat exchanger using the exhaust gas stream from the steam reforming to begin the regeneration process of separating carbon dioxide from the solvent. The third heat exchanger produces a cooled exhaust gas stream that is released into the environment. The heated carbon dioxide rich solvent stream flows to a flash tank operating at lower pressure which provides space for physical separation of the gas and liquid phases, producing a regenerated lean solvent stream and a gaseous stream including predominantly carbon dioxide and water vapor. The flash tank operates at a temperature in a range of 70 to 175° C. The exact operating temperature of the flash tank is a function of the thermal stability of the capture solvent, the temperature of the exhaust stream leaving the burner, the specific heat duty required for regeneration, and the desired capture rate. Higher temperature typically increases the water to carbon dioxide ratio in the off gas from the flash tank, reducing the specific reboiler duty. However, lower temperature increases the availability of heat in the exhaust gas to regenerate the solution. Selexol™ has a high thermal stability, typically up to around 175° C., whereas amines are usually limited to a maximum operating temperature of around 100-150° C. The regenerated solvent stream is fed to the second heat exchanger, as described above, to allow the process to continue to process additional fuel. In one or more embodiments, the regenerated solvent stream is preheated by one or more supplementary heat exchangers in series to optimize heat transfer in the second heat exchanger. The carbon dioxide stream is fed to a second knockout drum to remove liquid and produce a vapor carbon dioxide stream for temporary storage on a marine vessel.

The vapor carbon dioxide stream may be liquefied and/or compressed for temporary storage. In such embodiments, a liquefaction process is used following the second knockout drum. In one or more embodiments, a compressor is used following the second knockout drum. When a compressor is present, the vapor carbon dioxide stream is compressed to a pressure in a range of 100 to 150 bar. The carbon dioxide will accumulate and be stored while the marine vessel is traveling. When the marine vessel reaches a port, it may be offloaded for distribution and storage on land.

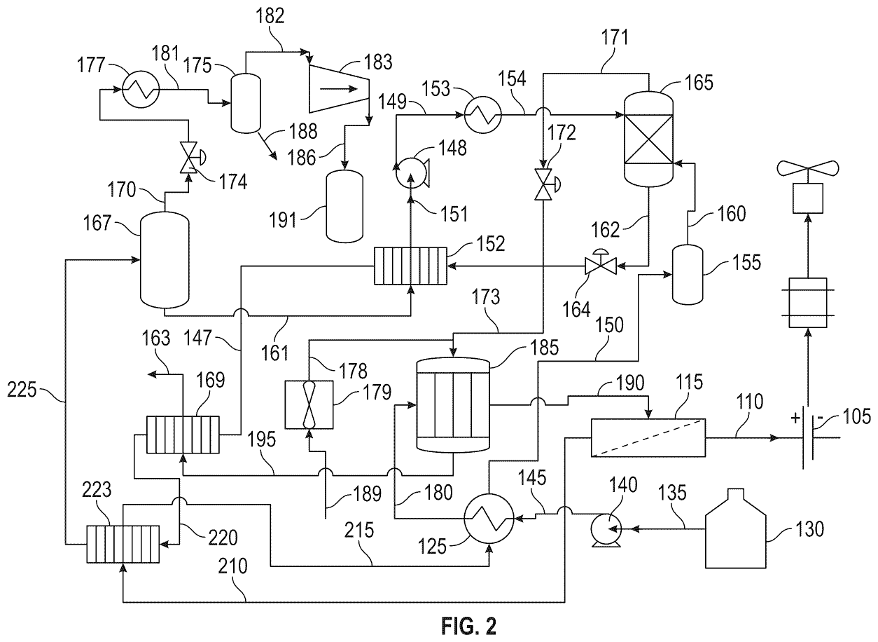

The carbon dioxide treatment portion of the system may also contain a fourth and fifth heat exchanger to further heat the carbon dioxide rich solvent stream and improve the yield of carbon capture. In one or more embodiments, the fourth and fifth heat exchangers are in series. In other embodiments, the fourth and fifth heat exchangers are in parallel. In other embodiments, there is only a fourth heat exchanger that is either in parallel or in series with the third heat exchanger. In the fourth heat exchanger, the heated carbon dioxide rich solvent stream may be further heated using the carbon monoxide and carbon dioxide rich syngas mixture, which is water-saturated, from the hydrogen purifier, as is discussed below in FIG. 2. In these embodiments, the fourth heat exchanger produces both a third heated carbon dioxide rich solvent stream and a second carbon monoxide and carbon dioxide rich syngas mixture. The third heated carbon dioxide rich solvent stream is directed to the flash tank to separate and store the carbon dioxide. The second carbon monoxide and carbon dioxide rich syngas mixture is directed to the first heat exchanger to provide heat to the pressurized fuel and water feed flowing towards the fuel reformer.

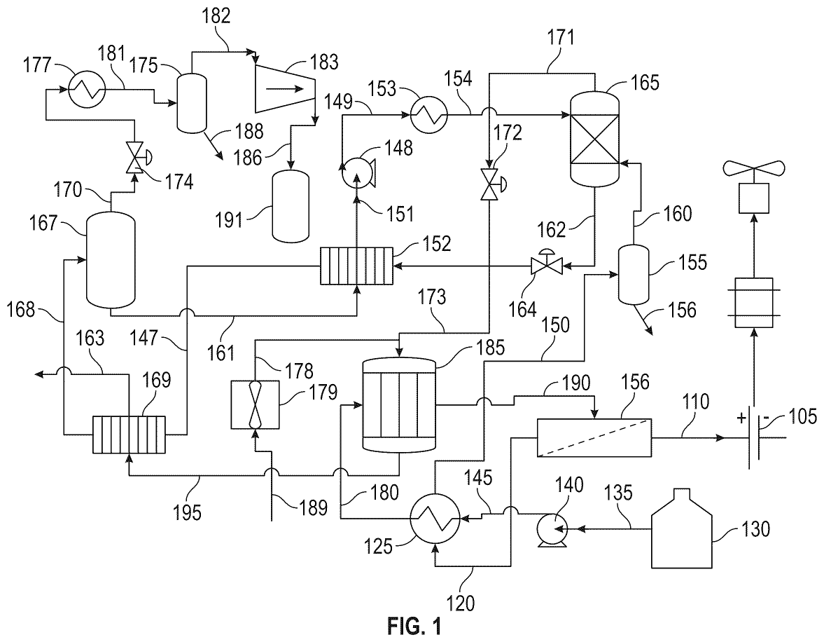

FIG. 1 illustrates the overall process flow diagram. A fuel and water feed 135 is pumped from a tank 130 through a flow line using a pump 140, producing a pressurized fuel and water feed 145. The pressurized fuel and water feed 145 is heated in a first heat exchanger 125 using a carbon monoxide and carbon dioxide rich syngas mixture 120, producing a heated pressurized fuel and water feed 180, which may be partially or fully vaporized, and a cooled carbon monoxide and carbon dioxide rich syngas mixture 150. In some embodiments, the fuel is aqueous methanol. In other embodiments, diesel, dimethyl-ether, natural gas, or other liquid fuels may be used. Renewable natural-gas (typically produced via anaerobic bio-fermentation) derived methanol may be used, as it reduces the lifecycle carbon intensity of the conventionally used methanol by approximately 45%. A molar ratio range between 0.5 and 1.0 water to methanol may be suitable for the reformer. In other embodiments, the molar range may be between 2.0 to 1.0 water to methanol. Using aqueous methanol increases the hydrogen content of the reformer effluent at the expense of reduced carbon monoxide, which is later combusted to provide energy for reforming, and increased carbon dioxide concentration allowing more to be captured. However, as a result, it also reduces the burner heat available and increases energy required for vaporizing the fuel. Lower methanol purity and higher water concentration may be less expensive to produce, especially considering the limit of 95%, above which distillation alone cannot be used for purification due to the methanol-water azcotrope. In practice, a methanol concentration of around 60-80% by mass may be advantageous in order to achieve a high hydrogen yield from the reformer, produce a stream with high carbon dioxide concentration suitable for capture, avail low-cost fuel sources, maintain sufficient energy content of the syngas retentate from the hydrogen separator (burner feed gas), and avoid excessive heat requirements for vaporizing the fuel.

The heated pressurized fuel and water feed 180 is reformed in a fuel reformer 185, producing a raw syngas mixture 190 containing hydrogen, carbon monoxide, carbon dioxide, water, and a residual amount of fuel, and an exhaust gas stream 195. The reformer 185 is coupled to a burner with a blower 179 for providing combustion air 178 to the burner. The blower 179 is fed by a blower feed stream 189. In one or more embodiments, the blower feed stream 189 includes air. The burner burns a low pressure carbon monoxide rich syngas mixture 173 to provide heat to the reformer 185. A hydrogen purifier 115 extracts a hydrogen stream 110 from the raw syngas mixture 190. The hydrogen stream 110 is directed to a fuel cell 105 for producing electricity. The produced electricity may be used when the electricity grid is unavailable as remote or backup power. When extracting hydrogen, the hydrogen purifier 115 produces a carbon monoxide and carbon dioxide rich syngas mixture 120, which is fed to the first heat exchanger 125, as described above, to provide heat to the pressurized fuel and water feed 145. In one or more embodiments, the purifier is a hydrogen-selective membrane. The cooled carbon monoxide and carbon dioxide rich syngas mixture 150 exiting the first heat exchanger is fed to a first liquid knockout drum 155 to remove excess liquid from the mixture, producing a dried cooled carbon monoxide and carbon dioxide rich syngas mixture 160 and a liquid waste stream 156. The dried cooled carbon monoxide and carbon dioxide rich syngas mixture 160 enters into the absorber 165. In one or more embodiments, the absorber is a counter-flow column, a cross flow absorber, a rotating packed bed absorber, or a hollow fiber membrane contactor absorber. In a counter-flow column, liquid enters from the top and exits from the bottom, while the gas enters from the bottom and exits from the top. The counter-flow column may include structured or random packing to create interfacial area between the gas and liquid phases. In a cross flow absorber, liquid enters from the top and leaves from the bottom while gas enters from one side and leaves from the other side of the absorber. In a rotating packed bed absorber, a rotating bed is used to create intimate interaction between a gas and liquid phase. In a hollow fiber membrane contactor absorber, small fibers containing the capture solvent bring the solvent into contact with the gas phase, generating a large amount of interfacial area between the phases to facilitate mass transfer while keeping the phases physically separate. In one or more embodiments, the absorber contains a backpressure valve at an outlet to maintain a system pressure. In one or more embodiments, the exhaust gas stream 195 exiting the reformer 185 may provide heat to the absorber 165 (process not shown). In one or more embodiments, the dried cooled carbon monoxide and carbon dioxide rich syngas mixture 160 may be cooled to below 40° C., in addition to the heat removed in the first heat exchanger, to reduce energy requirements for solvent regeneration and improve solvent capacity in the absorber.

The absorber 165 produces a carbon monoxide rich syngas mixture 171 which flows through a burner feed pressure regulator 172, producing a low pressure carbon monoxide rich syngas mixture 173. The low pressure carbon monoxide rich syngas mixture 173 is directed to the reformer 185. The absorber 165 also produces a carbon dioxide rich solvent stream 162 which is fed to a carbon dioxide treatment portion of the system, separating the carbon dioxide from the solvent to regenerate it for further use while isolating carbon dioxide for storage. The carbon dioxide rich solvent stream 162 flows through a solvent flow control valve 164.

The carbon dioxide rich solvent stream 162 is heated in a second heat exchanger 152 using a regenerated solvent stream 161, producing a heated carbon dioxide rich solvent stream 147 and a cooled regenerated solvent stream 151. The cooled regenerated solvent stream 151 is pumped in a second pump 148, producing a pumped cooled regenerated solvent stream 149, which is further cooled using a solvent trim cooler 153 to produce a further cooled regenerated solvent stream 154 to feed to the absorber 165. The solvent trim cooler 153 may cool the regenerated solvent stream to a temperature in a range of 10 to 80° C.

The heated carbon dioxide rich solvent stream 147 is heated in a third heat exchanger 169 using the exhaust gas as a heat source, producing a further heated carbon dioxide rich solvent stream 168 and a cooled exhaust gas stream 163. The further heated carbon dioxide rich solvent stream 168 is fed to a flash tank 167 to separate a carbon dioxide stream 170 from the regenerated solvent stream 161. The flash tank may operate at a temperature in a range of 70 to 175° C. In addition to separating the carbon dioxide rich solvent stream 168, the flash tank 167 may also produce steam. The regenerated solvent stream 161 flows to the second heat exchanger 152, as described above. The carbon dioxide stream 170 flows through a flash control valve 174 and through a condenser 177, producing a gas/liquid mixture containing gaseous carbon dioxide and liquid components (e.g., water and methanol) 181. In other words, the condenser 177 condenses the water and methanol within the carbon dioxide stream 170, producing a gas/liquid mixture containing gaseous carbon dioxide and liquid components (the condensed water and methanol) 181. The gas/liquid mixture is cooled in the condenser 177 and may be at a temperature between 10 to 70° C. The gas/liquid mixture 181 flows to a second knockout drum 175 to separate the liquid components 188 from the vapor carbon dioxide 182. The vapor carbon dioxide 182 is then compressed in a compressor 183, producing a compressed liquid carbon dioxide stream 186. The compressed liquid carbon dioxide stream 186 flows to a carbon dioxide storage tank 191 for temporary storage on the marine vessel.

FIG. 2 illustrates an alternative embodiment of an overall process flow diagram of a carbon capture system. Though many primary components are as described with reference to FIG. 1, a fourth heat exchanger is included that is in series with the third heat exchanger. In FIG. 1, the heated carbon dioxide rich solvent stream 147 is heated in a third heat exchanger 169 using the exhaust gas as a heat source, producing a further heated carbon dioxide rich solvent stream 168 and a cooled exhaust gas stream 163. The further heated carbon dioxide rich solvent stream 168 is directed to the flash tank 167. In FIG. 2, the further heated carbon dioxide rich solvent stream 220 flows to a fourth heat exchanger 223 instead of directly to the flash tank 167. The further heated carbon dioxide rich solvent stream 220 is heated by the carbon monoxide and carbon dioxide rich syngas mixture 210 from the hydrogen purifier, producing a third heated carbon dioxide rich solvent stream 225 and a second carbon monoxide and carbon dioxide rich syngas mixture 215. The third heated carbon dioxide rich solvent stream 225 flows to the flash tank 167 to continue the process as described above in FIG. 1, where the heated carbon dioxide rich solvent stream goes through a flash tank, a condenser, a second knockout drum, a compressor, and flows to a storage tank. The second carbon monoxide and carbon dioxide rich syngas mixture 215 flows back to the first heat exchanger 125 to provide heat to the pressurized fuel and water feed 145 before entering into the reformer 185. The addition of the fourth heat exchanger may provide more effective heating to the further heated carbon dioxide rich solvent stream prior to flashing, thus separating carbon dioxide and regenerating the solvent more effectively.

### EXAMPLE

A case study was conducted based on a small pilot-scale process. The pilot system utilized around 140 kW of electricity and would be expected to be scaled up between four to six times that of the pilot-scale process. Table 1 provides the gas conditions for the pilot-scale process. Table 2 provides optimal conditions identified in the case study.

TABLE 1

| | Carbon Monoxide | | Exhaust Gas (heat for | |
|---|---|---|---|---|
| | Rich Syngas Mixture | | capture system) | |
| | | Mass Flow | | Mass Flow |
| | Mol | Rate | Mole | Rate |
| Component | fraction | (kg/hr) | fraction | (kg/hr) |
| CO | 10.6% | 24 | 0.00% | 0.0 |
| CO₂ | 43.7% | 156 | 4.88% | 185.6 |
| H2 | 29.3% | 5 | 0.00% | 0.0 |
| H₂O | 16.4% | 24 | 12.02% | 187.1 |
| N₂ | 0.0% | 0 | 83.11% | 2012.8 |

| | | |
|---|---|---|
| Total Flow Rate | 209 | 2386 |
| (kg/hr) | | |
| Temperature (° C.) | 40 | 230 |
| Pressure (atm) | 18.35 | 1 |

| Parameter | Optimal Value | |
|---|---|---|
| Lean loading | 0.03 mol. Frac CO2 in Selexol ™ solvent | |
| Liquid rate | 39 | k kg/min |
| Temp flash | 150 | C. |
| Pressure flash | 7.0 | bar |
| Capture rate | 88% | |
| Electrical parasitic draw | 4.2% | |
| Spec. Heat | 1.22 | kJ/g CO₂ |
| Spec. Work | 0.30 | kJ/g CO₂ |

In this example, Selexol™ is used as the solvent. The absorber diameter is adjusted to meet either a minimum 15% flooding or a maximum of 80% flooding. The approach temperature of the heat exchanger (FIG. 1, 152) in the absorber effluent line is held at a constant log mean temperature difference of 7° C. The absorber height was fixed at 1.4 meters.

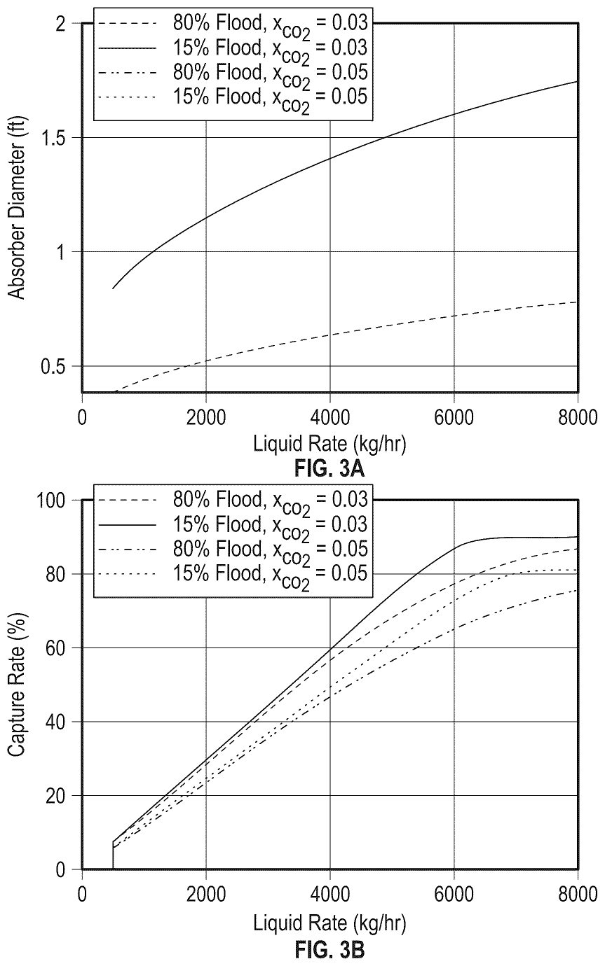

FIG. 3A shows the absorber diameter against liquid flow rate for a minimum of 15% flooding (larger diameter) and a maximum of 80% flooding (smaller diameter) at a carbon dioxide mole fraction of 0.03. The minimum of 15% flooding requires much larger absorber diameters to achieve the same liquid flow rate, on the magnitude of over twice the diameter of the maximum of 80% flooding absorber. Larger diameter columns can accommodate a greater gas residence time and wetted area to increase CO₂ absorption in rate-limited applications, given a height limit which may be present on the vessel. However, they will typically increase cost compared with smaller diameter columns.

FIG. 3B shows the absorber percentage capture rate against liquid flow rate for a minimum of 15% flooding and a maximum of 80% flooding at carbon dioxide mole fractions of 0.03 and 0.05. Though relatively comparable, the lower carbon dioxide mole fraction yielded higher absorber percentage capture rates, with the minimum of 15% flooding yielding the highest. For each mole fraction, the case with minimum of 15% flooding yielded the highest capture rate. This can be attributed to the greater volume of packing, thus greater gas liquid interfacial area and greater gas residence time, in this arrangement.

As shown in FIG. 3B, capture rates first increase linearly with increasing liquid flow rates, indicating a “rich pinch,” when rich solvent approaches equilibrium with the incoming gas. At higher liquid flow rates, capture rates level off indicating a “lean pinch,” when incoming solvent is approaching equilibrium with the exiting gas. The capture rate then plateaus around a maximum capture rate which is determined by the lean loading, with lower lean loadings producing a higher maximum capture rate.

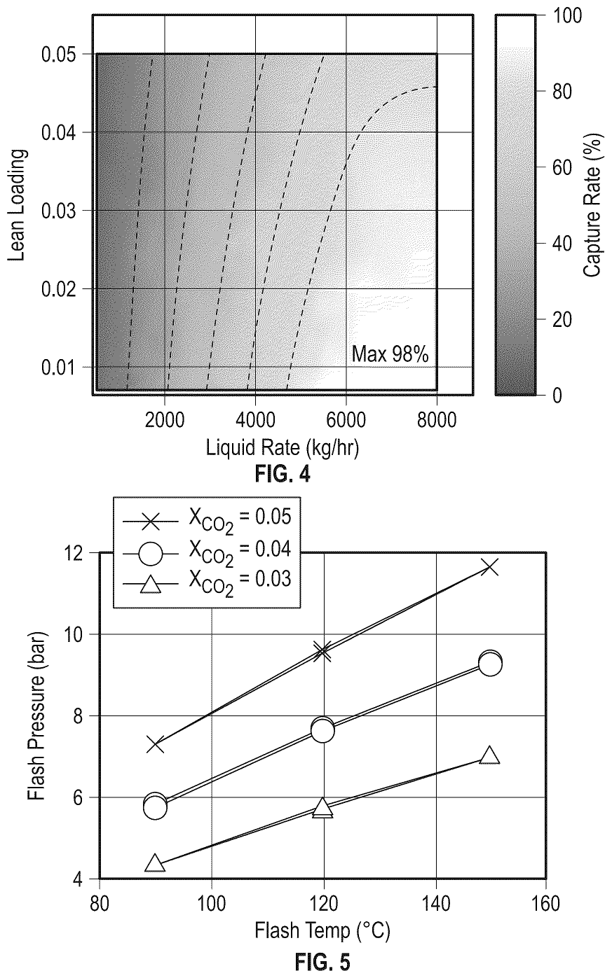

FIG. 4 shows the lean loading against liquid flow rate. The capture rates are highest at high liquid flow rates and appear to be mostly independent of the lean loading.

FIG. 5 shows the flash pressure against flash temperature for carbon dioxide mole fractions of 0.03, 0.04, and 0.05. The results indicate that the higher the mole fraction, the higher the corresponding flash pressure is relative to each flash temperature. The minimum lean loading considered is determined by the flash temperature and a pressure of 1 atm to avoid vacuum stripping. If the flash tank is operated at higher temperatures, a lower minimum lean loading and higher maximum capture rate can be achieved.

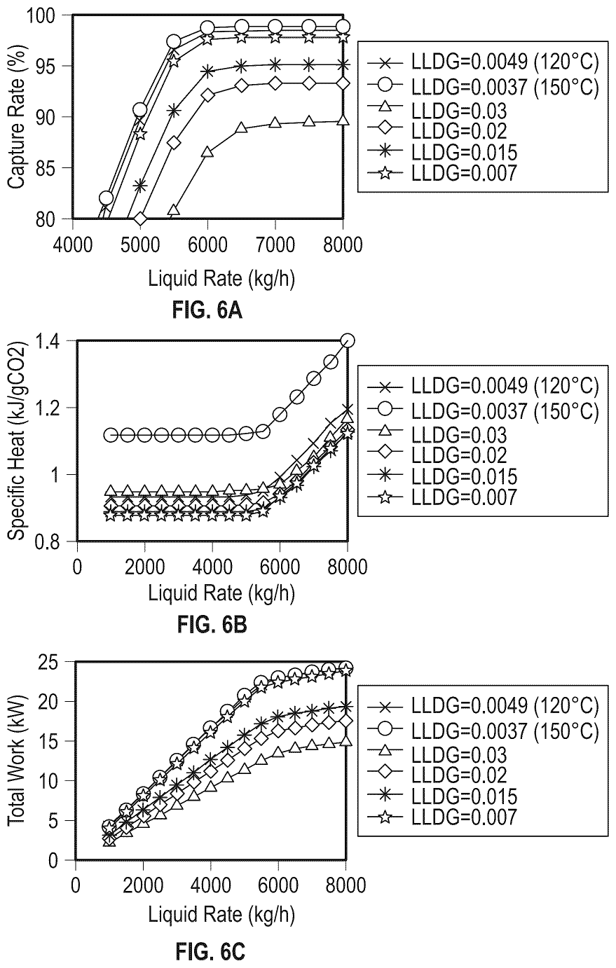

FIG. 6A shows the absorber percentage capture rate against liquid flow rate at varying LLDG values. LLDG is defined as the lean carbon dioxide loading, where carbon dioxide loading refers to the concentration of carbon dioxide in the solvent fed to the absorber. The lower LLDG values yielded higher capture rates at a given liquid flow rate. For amine solvents, this may be expressed as the moles of carbon dioxide per mole of amine, nitrogen atom, or alkaline group. For physical solvents, like Selexol™, a mole fraction of carbon dioxide may be used for LLDG.

FIG. 6B shows the specific heat against liquid flow rate at varying LLDG values. While most results were relatively comparable, an LLDG of 0.0037, the lowest LLDG tested, resulted in a substantially higher specific heat at a given flow rate. A minimum specific heat duty can be achieved by selecting the optimal combination of liquid flow rate and lean loading for a given desired capture rate. Because all of the cases considered have a specific heat duty less than the available heat, minimizing the specific heat duty is of secondary concern to other factors, such as the system size, cost, and power requirements.

FIG. 6C shows total work against liquid flow rate at varying LLDG values. Notably, the higher values of LLDG yielded lower total work at a given liquid flow rate. Although a majority of the energy to power the system is provided by the exhaust gas heat, a portion of energy must be provided to run the pump to circulate the solvent between the high-pressure absorber and the flash tank, and to compress the carbon dioxide after capture. The total power increases with liquid flow rate due to the increased amount of carbon dioxide requiring compression and the increase in pump power requirements to circulate the higher liquid flow rates. Operating at higher lean loading reduces the compressor work, as the flash tank operates at a higher pressure, allowing the carbon dioxide to enter the compressor at a higher pressure. To achieve at least a 90% capture rate while keeping the work between 5-10% of the fuel cell output of 140 kW, it may be desirable to operate the system at a liquid rate of approximately 5,000-6,000 kg/hour for the minimum of 15% flooding conditions (with a liquid to gas ratio in the range of 24-29), and a lean loading in a range of 0.015-0.02 mol fraction carbon dioxide. For the maximum of 80% flooding case, a liquid flow rate of around 7,000-9,000 kg/hour may be required (with a liquid to gas ratio in the range of 33-43).

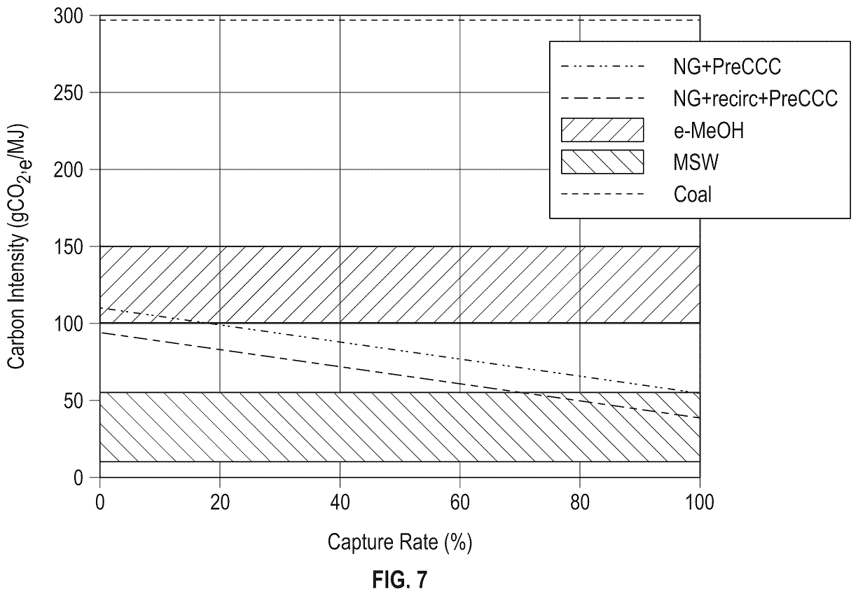

FIG. 7 shows the lifecycle greenhouse-gas (or “carbon”) intensity against the onboard capture rate. Higher capture rates lead to lower carbon intensities. When using gray methanol (produced from natural gas reforming) as a fuel, carbon capture can reduce the lifecycle greenhouse gas (GHG) intensity to roughly parity with some “green” methanol (typically produced from renewable natural gas). When using green methanol as a fuel and adding carbon capture, the result can be full carbon neutrality or even carbon negativity-since the endogenous carbon dioxide being captured from the burner feed is biogenic carbon dioxide.

Further, to measure the performance of the system, the carbon dioxide removed from the feed stream relative to the total amount of carbon dioxide is calculated and referred to as the capture rate. The system can only remove carbon dioxide in the feed to the methane reformer. Furthermore, the system does not capture upstream carbon dioxide emissions produced during the production or transportation of the fuel. The exhaust gas from the burner contains carbon dioxide that accounts for around 72% of the total for gray methanol. Around 80% of this carbon dioxide is present as carbon dioxide in the stream feeding the absorber and thus is available for capture (the rest is present as carbon monoxide). Thus, the fuel is not fully carbon dioxide reduction.

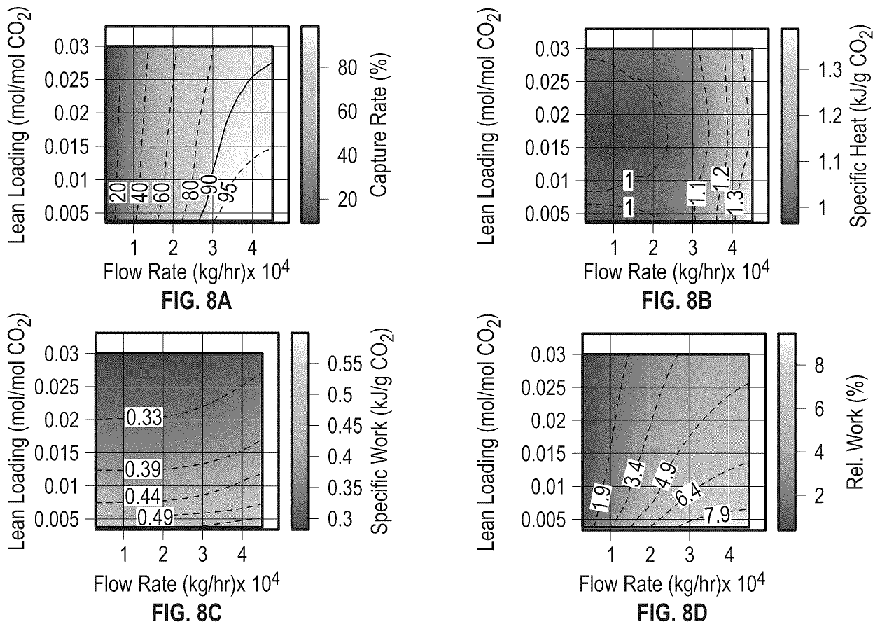

FIG. 8A-8D show lean loading against flow rate. FIG. 8A shows both lean loading and capture rate against flow rate. Specifically, it illustrates that 90% capture rate is achievable with higher flow rates. FIG. 8B shows both lean loading and specific heat against flow rate. Specifically, it illustrates that the specific heat is very low in the pilot scale process. FIG. 8C shows lean loading and specific work against flow rate, while FIG. 8D shows lean loading and relative work against flow rate. Both FIG. 8C and 8D indicate that parasitic work is reasonable in the pilot scale process.

Embodiments of the present disclosure may provide at least one of the following advantages. Carbon dioxide emissions from marine vessels are directly captured to reduce the greenhouse gas emissions of the maritime industry. The steam reforming process provides motive power to the marine vessel by providing power to the motor, to spin a propeller, and to propel the ship. The system is able to use high pressures generated by the steam reforming process to drive the carbon dioxide separation.

In addition to marine vessels, the present disclosure may be applied to other mobile vessels such as, but not limited to, electric vehicles. For example, the disclosure may be particularly relevant to providing remote or backup power generation for off-grid electrical vehicle charging.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A hydrogen generation and carbon capture system for marine applications, comprising:
a fuel reformer for reacting a fuel and water feed from a marine vessel to produce a raw syngas mixture containing hydrogen, carbon monoxide, carbon dioxide, water, and a residual amount of fuel;
a hydrogen purifier for extracting a hydrogen stream from the raw syngas mixture, producing a carbon monoxide and carbon dioxide rich syngas mixture;
a fuel cell for producing electricity from the hydrogen stream as a power source;
a first heat exchanger for transferring heat from the carbon monoxide and carbon dioxide rich syngas mixture to the fuel and water feed, producing a cooled carbon monoxide and carbon dioxide rich syngas mixture;
a first knockout drum for removing an amount of liquid from the carbon monoxide and carbon dioxide rich syngas mixture, producing a dried cooled carbon monoxide and carbon dioxide rich syngas mixture;
an absorber for transferring an amount of carbon dioxide from the dried cooled carbon monoxide and carbon dioxide rich syngas mixture to a further cooled regenerated solvent stream, producing a carbon dioxide rich solvent stream and a carbon monoxide rich syngas mixture;
a burner feed pressure regulator for reducing the pressure of the carbon monoxide rich syngas mixture to produce a low pressure carbon monoxide rich syngas mixture;
a burner coupled to the fuel reformer to provide heat to the fuel reformer by combusting the low pressure carbon monoxide rich syngas mixture, producing an exhaust gas;
a second heat exchanger for transferring heat from a regenerated solvent stream to the carbon dioxide rich solvent stream, producing a cooled regenerated solvent stream and a heated carbon dioxide rich solvent stream;
a third heat exchanger for providing additional heat to the heated carbon dioxide rich solvent stream using heat from the exhaust gas to regenerate the heated carbon dioxide rich solvent stream;
a flash tank for further separation of the heated carbon dioxide rich solvent stream to produce the regenerated solvent stream and a carbon dioxide stream;
a solvent trim cooler to further reduce a temperature of the cooled regenerated solvent stream into the absorber producing the further cooled regenerated solvent stream;
a condenser for producing a gas/liquid mixture containing gaseous carbon dioxide and liquid components; and
a second knockout drum for removing the liquid components from the gas/liquid mixture, producing a vapor carbon dioxide stream for temporary storage on a marine vessel before unloading on land.

2. The hydrogen generation and carbon capture system of claim 1, wherein the hydrogen purifier is a hydrogen-selective membrane.

3. The hydrogen generation and carbon capture system of claim 1, further comprising a backpressure valve at an outlet of the absorber to maintain a system pressure.

4. The hydrogen generation and carbon capture system of claim 1, wherein the power source is connected to a marine vessel.

5. The hydrogen generation and carbon capture system of claim 1, further comprising a condenser unit for liquefying the vapor carbon dioxide stream for temporary storage on a marine vessel before unloading on land.

6. The hydrogen generation and carbon capture system of claim 1, further comprising a compressor for compressing the vapor carbon dioxide stream for temporary storage on a marine vessel before unloading on land.

7. The hydrogen generation and carbon capture system of claim 1, wherein the absorber is selected from the group consisting of a counter-flow column, a cross flow absorber, a rotating packed bed absorber, or a hollow fiber membrane contactor absorber.

8. The hydrogen generation and carbon capture system of claim 1, further comprising a fourth heat exchanger in series with the third heat exchanger for heating the further heated carbon dioxide rich solvent stream.

9. A process for hydrogen generation and carbon capture for marine applications, comprising:
pumping a fuel and water feed from a marine vessel, producing a pressurized fuel and water feed;
heating the pressurized fuel and water feed via a first heat exchanger using a carbon monoxide and carbon dioxide rich syngas mixture, producing a heated pressurized fuel and water feed and a cooled carbon monoxide and carbon dioxide rich syngas mixture;
reforming the heated pressurized fuel and water feed using a fuel reformer, producing a raw syngas mixture containing hydrogen, carbon monoxide, carbon dioxide, water, and a residual amount of fuel;
extracting the hydrogen from the raw syngas mixture using a hydrogen purifier, producing a hydrogen stream and the carbon monoxide and carbon dioxide rich syngas mixture;
directing the hydrogen stream to a fuel cell for producing electricity;
separating an amount of liquid from the cooled carbon monoxide and carbon dioxide rich syngas mixture using a first knockout drum, producing a dried cooled carbon monoxide and carbon dioxide rich syngas mixture and a liquid waste stream;
feeding the dried cooled carbon monoxide and carbon dioxide rich syngas mixture and a further cooled regenerated solvent stream to an absorber to selectively transfer the carbon dioxide from the dried cooled carbon monoxide and carbon dioxide rich syngas mixture to the further cooled regenerated solvent stream, producing a carbon dioxide rich solvent stream and a carbon monoxide rich syngas mixture;
reducing pressure of the carbon monoxide rich syngas mixture using a burner feed pressure regulator, producing a low pressure carbon monoxide rich syngas mixture;
burning the low pressure carbon monoxide rich syngas mixture in a burner coupled to the fuel reformer to provide heat to the fuel reformer, producing an exhaust gas stream;
heating the carbon dioxide rich solvent stream via a second heat exchanger using a regenerated solvent stream, producing a cooled regenerated solvent stream and a heated carbon dioxide rich solvent stream;
further cooling the cooled regenerated solvent stream using a solvent trim cooler, producing the further cooled regenerated solvent stream;
further heating the heated carbon dioxide rich solvent stream via a third heat exchanger using the exhaust gas to heat the heated carbon dioxide rich solvent stream, producing a further heated carbon dioxide rich solvent stream and a cooled exhaust gas stream;
separating a portion of carbon dioxide from the further heated carbon dioxide rich solvent stream using a flash tank, producing the regenerated solvent stream and a carbon dioxide stream;
condensing the carbon dioxide stream to produce a gas/liquid mixture containing gaseous carbon dioxide and liquid components; and
separating the liquid components from the gas/liquid mixture using a second knockout drum, producing a vapor carbon dioxide stream for temporary storage on a marine vessel before unloading on land.

10. The process of claim 9, wherein producing electricity provides motive power to a marine vessel.

11. The process of claim 10, wherein the produced electricity is used for remote or backup power.

12. The process of claim 9, further comprising compressing the vapor carbon dioxide stream to form a compressed liquid carbon dioxide stream, having a pressure in a range of 100 to 152 bar, for temporary storage on a marine vessel before unloading on land.

13. The process of claim 9, further comprising monitoring a pressure at an outlet of the absorber to ensure the pressure is at least 5 atm.

14. The process of claim 9, wherein the flash tank operates at a temperature in a range of 70 to 175° C.

15. The process of claim 9, wherein the solvent trim cooler cools the cooled regenerated solvent stream to a temperature in a range of 10 to 80° C.

16. The process of claim 9, wherein the regenerated solvent stream contains a high-capacity chemical solvent selected from the group consisting of methyl-diethanolamine, diethanolamine, piperazine, and diglycolamine.

17. The process of claim 9, wherein the regenerated solvent stream contains a physical solvent mixture selected from the group consisting of dimethyl ethers of polyethylene glycol, methanol, sulfolane, pyrrolidones, imidazoles, organic carbonates, poly-ethers, polyols, or combinations thereof.

18. The process of claim 9, wherein the regenerated solvent stream contains both a high-capacity chemical solvent and a physical solvent.

19. The process of claim 9, wherein the fuel is selected from the group consisting of methanol, diesel, liquid fuel, and natural gas.

20. The process of claim 9, wherein the regenerated solvent stream contains 30 to 80% amine in water.
